(19) United States
(12) Patent Application Publication
(10) Pub. No.: US 2026/0220259 A1
(43) Pub. Date: Jul. 30, 2026

(54) TECHNIQUES FOR DIGITAL ASSET GROUPING FOR CYBERSECURITY POSTURE MANAGEMENT

(71) Applicant: Cycognito, Ltd., Tel Aviv (IL)

(72) Inventors: Rob N GURZEEV, Palo Alto, CA (US); Dima POTEKHIN, Tel Aviv (IL)

(73) Assignee: Cycognito, Ltd., Tel Aviv (IL)

(21) Appl. No.: 19/038,231

(22) Filed: Jan. 27, 2025

(51) Int. Cl. G06F 21/55

(52) U.S. Cl. CPC G06F 21/554; G06F 2221/034

(57) ABSTRACT

A system and method for cybersecurity posture management including an external attack surface is presented. The method detecting a plurality of digital assets, wherein at least a portion of the plurality of digital assets are accessible through a public network; generating an asset group based on a first digital asset and a second digital asset of the plurality of digital assets; receiving alerts related to each of the first digital asset and the second digital asset; generating a primary alert based on the received alerts; and initiating a mitigation action based only on the primary alert.

### TECHNICAL FIELD

The present disclosure relates generally to cybersecurity posture management, and specifically to reducing

### BACKGROUND

Cloud Security Posture Management (CSPM) is a set of tools and practices designed to ensure security and compliance in cloud environments. It identifies misconfigurations, monitors compliance with regulatory standards, and provides visibility into security risks across cloud resources. CSPM tools automate the detection of vulnerabilities, such as improperly configured storage buckets, open ports, or excessive permissions, to help organizations maintain a secure and compliant cloud infrastructure.

One problem with CSPM is the challenge of handling false positives and false negatives. Due to the dynamic and complex nature of cloud environments, CSPM tools may flag benign configurations as risks (false positives) or miss actual vulnerabilities (false negatives). False positives can overwhelm security teams with unnecessary alerts, leading to alert fatigue and reduced efficiency. Conversely, false negatives can result in overlooked vulnerabilities, leaving the environment exposed to potential threats.

Additionally, CSPM solutions often struggle with contextual awareness, as they may not fully understand the business context of a specific configuration. For instance, a flagged risk might actually be an intentional and acceptable exception based on the organization’s specific needs, but the tool lacks the context to determine this.

Another issue is scalability and integration. As organizations adopt multi-cloud strategies, CSPM tools must integrate across diverse cloud platforms and adapt to varying APIs, configurations, and policies. This complexity can limit their effectiveness and create coverage gaps in hybrid or multi-cloud setups.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

In one general aspect, a method may include detecting a plurality of digital assets, where at least a portion of the plurality of digital assets are accessible through a public network. The method may also include generating an asset group based on a first digital asset and a second digital asset of the plurality of digital assets. The method may furthermore include receiving alerts related to each of the first digital asset and the second digital asset. The method may in addition include generating a primary alert based on the received alerts. The method may moreover include initiating a mitigation action based only on the primary alert. Other embodiments of this aspect include corresponding computer systems, apparatus, and computer programs recorded on one or more computer storage devices, each configured to perform the actions of the methods.

Implementations may include one or more of the following features. The method may include: assigning a priority to the mitigation action, where the mitigation action is a mitigation action of a plurality of mitigation actions. The method may include: initiating the mitigation action based on the assigned priority. The method may include: determining that the first digital asset is associated with the second digital asset based on a domain name service (DNS) record. The method may include: generating a first fingerprint for the first digital asset; generating a second fingerprint for the second digital asset; determining that the first digital asset is associated with the second digital asset based on a match between the first fingerprint and the second fingerprint. The method may include: generating a third fingerprint for a third digital asset; generating a second asset group in response to determining that the third fingerprint mismatches the first fingerprint; and associating the third fingerprint with the second asset group. The method may include: determining that the first digital asset is associated with the second digital asset; and generating the asset group in response to determining the association. The method may include: initiating mitigation actions based only on primary alerts. Implementations of the described techniques may include hardware, a method or process, or a computer tangible medium.

In one general aspect, non-transitory computer-readable medium may include one or more instructions that, when executed by one or more processing circuitries of a device, cause the device to: detect a plurality of digital assets, where at least a portion of the plurality of digital assets are accessible through a public network; generate an asset group based on a first digital asset and a second digital asset of the plurality of digital assets; receive alerts related to each of the first digital asset and the second digital asset; generate a primary alert based on the received alerts; and initiate a mitigation action based only on the primary alert. Other embodiments of this aspect include corresponding computer systems, apparatus, and computer programs recorded on one or more computer storage devices, each configured to perform the actions of the methods.

In one general aspect, a system may include one or more processing circuitries configured to: detect a plurality of digital assets, where at least a portion of the plurality of digital assets are accessible through a public network. The system may furthermore generate an asset group based on a first digital asset and a second digital asset of the plurality of digital assets. The system may in addition receive alerts related to each of the first digital asset and the second digital asset. The system may moreover generate a primary alert based on the received alerts. The system may also initiate a mitigation action based only on the primary alert. Other embodiments of this aspect include corresponding computer systems, apparatus, and computer programs recorded on one or more computer storage devices, each configured to perform the actions of the methods.

Implementations may include one or more of the following features. The system where the one or more processing circuitries are further configured to: assign a priority to the mitigation action, where the mitigation action is a mitigation action of a plurality of mitigation actions. The system where the one or more processing circuitries are further configured to: initiate the mitigation action based on the assigned priority. The system where the one or more processing circuitries are further configured to: determine that the first digital asset is associated with the second digital asset based on a domain name service (DNS) record. The system where the one or more processing circuitries are further configured to: generate a first fingerprint for the first digital asset; generate a second fingerprint for the second digital asset; and determine that the first digital asset is associated with the second digital asset based on a match between the first fingerprint and the second fingerprint. The system where the one or more processing circuitries are further configured to: generate a third fingerprint for a third digital asset; generate a second asset group in response to determining that the third fingerprint mismatches the a first fingerprint; and associate the third fingerprint with the second asset group. The system where the one or more processing circuitries are further configured to: determine that the first digital asset is associated with the second digital asset; and generate the asset group in response to determining the association. The system where the one or more processing circuitries are further configured to: initiate mitigation actions based only on primary alerts. Implementations of the described techniques may include hardware, a method or process, or a computer tangible medium.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a computing environment having persistent digital assets discovered by an external attack surface detector, utilized to describe an embodiment.

FIG. 2 is a flowchart of a method for detecting digital asset groups, implemented in accordance with an embodiment.

FIG. 3 is a diagram of an external attack surface detector and a digital asset, utilized to describe an embodiment.

FIG. 4 is a flowchart of a method for detecting a digital asset in a networked computing environment, implemented in accordance with an embodiment.

FIG. 5 is a flowchart of a method for detecting persistent digital assets in a networked computing environment, implemented according to an embodiment.

FIG. 6 is an example schematic diagram of a detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to an embodiment, a system is configured to detect persistent digital assets through an external attack surface. In an embodiment, detecting a persistent digital asset is beneficial, as having an accurate view of an external attack surface is beneficial, for example for cybersecurity mitigation, remediation, and the like.

In some embodiments, a representation of a digital asset is generated based on information detected through a public network, such as the Internet. In an embodiment, information pertaining to a digital asset changes over time. For example, a digital asset has a first state at a first point of time, and a second state at a second point in time. In an embodiment, a state includes an IP address, an operating system, a viable network communication port, combinations thereof, and the like, as explained in more detail with respect to embodiments herein.

In an embodiment, it is beneficial to detect persistent digital assets, despite changes such as software updates, IP address changes, domain name changes, and the like, which occur over time.

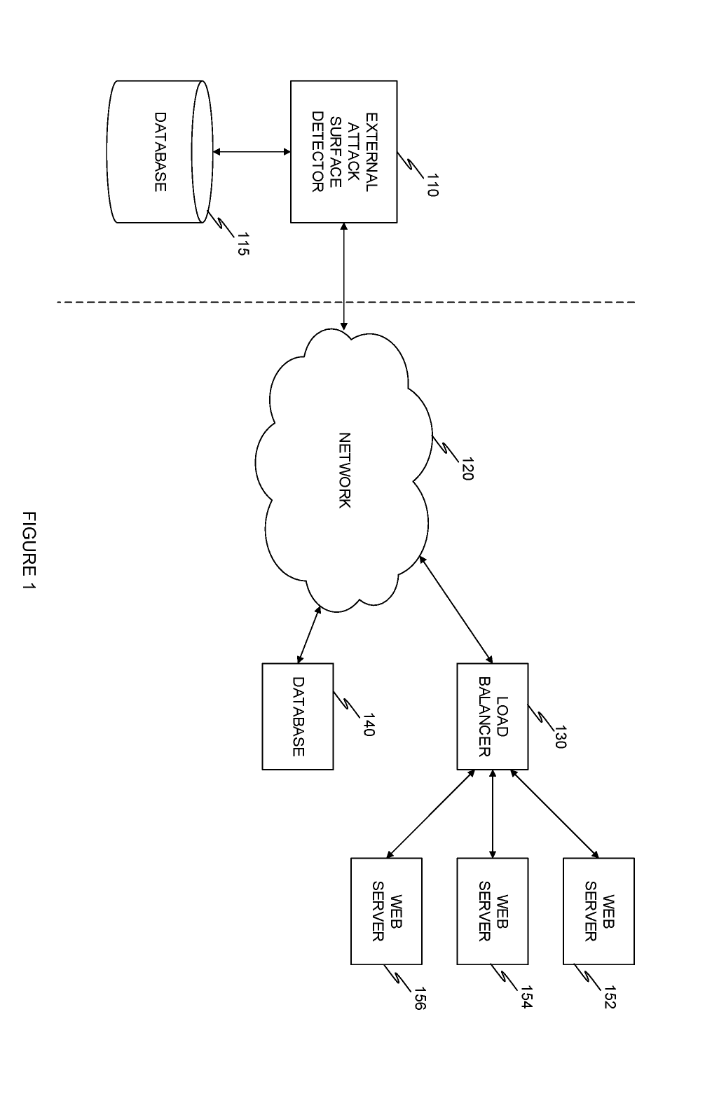

FIG. 1 is a network diagram of a computing environment having persistent digital assets discovered by an external attack surface detector, utilized to describe an embodiment. A network computing environment, according to an embodiment, includes virtual digital assets, physical digital assets, combinations thereof, and the like.

In an embodiment, a virtual digital asset is a virtual machine, a software container, a serverless function, a virtual appliance, an application image, a web server, a load balancer, a database, a distributed storage service, a combination thereof, and the like.

In some embodiments, a physical digital asset is a bare metal machine, a server rack, a processor, a memory, a storage, combinations thereof, and the like.

In an embodiment, a computing environment includes a load balancer 130, which exposes web servers, such as a first web server 152, a second web server 154, and a third web server 156. In some embodiments, the computing environment includes a database 140. In certain embodiments, the computing environment, elements thereof, and the like, are connected to a network 120.

In some embodiments, the network 120 includes, but is not limited to, a wireless, cellular or wired network, a local area network (LAN), a wide area network (WAN), a metro area network (MAN), the Internet, the worldwide web (WWW), similar networks, and any combination thereof.

According to an embodiment, a computing environment includes an external attack surface. An external attack surface includes, in an embodiment, machines, devices, digital assets, physical assets, and the like, which are exposed through a network 120, an external network (i.e., a network which is external to a network of the computing environment), a public network, combinations thereof, and the like.

For example, in an embodiment, a load balancer 130 is part of a computing environment’s external attack surface, as the load balancer 130 is exposed to a network which includes network elements that are not part of the computing environment. For example, a load balancer 130 that is exposed to the Internet is part of an attack surface, according to an embodiment. Gaining access through an external attack surface is a common way attackers gain access to network computing environments. It is therefore advantageous to detect an organization’s external attack surface, so that cybersecurity measures can be put in place, including deterring attackers, remediate attacks, mitigate attacks, and the like.

In certain embodiments, an external attack surface detector 110 is configured to detect a computing environment’s external attack surface. In some embodiments, a computing environment is a cloud computing environment, a networked computing environment, a hybrid computing environment, a combination thereof, and the like.

In some embodiments, a cloud computing environment is a virtual private cloud (VPC), a virtual network (VNet), and the like. In certain embodiments, a cloud computing environment is deployed on a cloud computing infrastructure, such as Amazon® Web Services (AWS), Google® Cloud Platform (GCP), Microsoft® Azure®, and the like.

In an embodiment, an external attack surface detector 110 is configured to detect the computing environment’s external attack surface, based on an identifier of an organization. For example, according to an embodiment, a detector 110 is configured to detect a domain name service (DNS) record based on the organization identifier. In an embodiment, a DNS record is detected by querying a DNS server with the organization identifier. An organization identifier is, for example, a legal entity name, a subsidiary name, a tax ID number, a company ID number, a combination thereof, and the like.

In certain embodiments, a DNS query returns a response including a plurality of network addresses. For example, according to an embodiment, a DNS query response includes a static IP address, a dynamic IP address, a combination thereof, and the like.

In an embodiment, a network protocol message is generated based on a network address detected in the DNS query response. For example, in an embodiment, a network protocol message includes generating a PING command to an IP address, a range of IP addresses, and the like, and receive a response to the network protocol message.

In certain embodiments, the network protocol is TCP/IP, UDP, HTTP, SSH, a combination thereof, and the like. In some embodiments, the network protocol message is delivered over a unique port, a plurality of unique ports, and the like. For example, in an embodiment, an HTTP message is generated, and the same message is transmitted over port 80 and port 8080 to the same IP address.

According to an embodiment, a reply is received in response to sending the network protocol message. For example, in an embodiment, an HTTP response includes a code, such as 304, 503, etc. In certain embodiments, a detector 110 is configured to generate a representation of a digital asset based on a predefined data schema and store such a representation in a database 115. For example, in an embodiment, the detector 110 is configured to generate a representation of a digital asset based on digital asset information.

In an embodiment, digital asset information includes a network address, a network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In an embodiment, the detector 110 is configured to extract a value from digital asset information, and store the extracted value in a representation of the digital asset, for example in the database 115. Digital assets are often not static across time, which presents a challenge in identifying persistent digital assets. As a simple example, a digital asset has a first IP address at a first time, and a second IP address at a second time. This can occur, for example, due to a change in a static IP of a domain. In an embodiment, such a change is detected based on a DNS record.

In certain embodiments, the detector 110 is configured to detect when digital asset information applies to an existing digital asset (e.g., a change of IP address), or when digital asset information applies to a new digital asset. In some embodiments the detector 110 is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector 110 is configured to detect, extract, and the like, a value from digital asset information, and store such an extracted value in the digital asset representation of the digital asset.

In some embodiments, the detector is configured to determine if a digital asset information applies to a new digital asset or a previously detected digital asset based on a threshold. For example, in an embodiment, an attribute includes a threshold, a change threshold, and the like. In certain embodiments, where an attribute value changes at a frequency which exceeds the threshold, the digital asset information is determined to be of a new digital asset.

In certain embodiments, the threshold is applied to a number of attributes changing together. For example, where digital asset information includes the same IP address with a different port, for the same protocol, the detector 110 is configured to determine that the digital asset is the previously detected digital asset (i.e., only one attribute changed). In an embodiment, where the digital asset information includes a different IP address, a different port, and the same protocol, the detector 110 is configured to determine that the digital asset information applies to a new digital asset.

In some embodiments, certain changes are disregarded in determining if the digital asset is a previously detected digital asset or not. For example, where a DNS record indicates that a domain changed an IP address, then each digital asset associated with the domain has likely changed IP address as well, and therefore the digital asset information pertaining to that digital asset is determined based on other factors, attributes, and the like, which are not the IP address.

According to an embodiment, a digital asset representation includes a generated fingerprint. For example, in an embodiment, the detector 110 is configured to generate a fingerprint for a digital asset based on at least an attribute. In some embodiments, the fingerprint is a hash value.

In an embodiment, the detector 110 is configured to detect an asset group. For example, the plurality of web servers 152 through 156 are an asset group, according to an embodiment. Detecting asset groups allows to unify assets and provide context for an asset, such as by providing a business context.

In an embodiment, a computing environment is configured to generate alerts, notifications, and the like, for various assets, components, etc., which are deployed therein. By generating an asset group, alerts can likewise be grouped, so as to generate fewer alerts, and increase the relevance of those alerts which are ultimately generated.

For example, according to an embodiment, the load balancer 130 experiences a malfunction. The load balancer 130 then generates a notification of the malfunction. Simultaneously, the web servers 152 through 156 detect no network connectivity, and likewise generate notifications. There are now four components in the computing environment generating notifications for what is essentially a single event. By grouping the load balancer 130 and web servers 152 through 156 as a single asset, a primary alert is generated based on the notifications of each component, thus reducing the overall number of alerts significantly, and reducing alert fatigue.

Alert fatigue occurs when individuals, such as IT or security professionals, are overwhelmed by a high volume of alerts, often including false positives or low-priority notifications. This leads to desensitization, where critical alerts may be ignored or missed, increasing the risk of significant incidents going unnoticed. It is a common issue in environments with poorly tuned monitoring systems, making it essential to prioritize, filter, and contextualize alerts to ensure effective response.

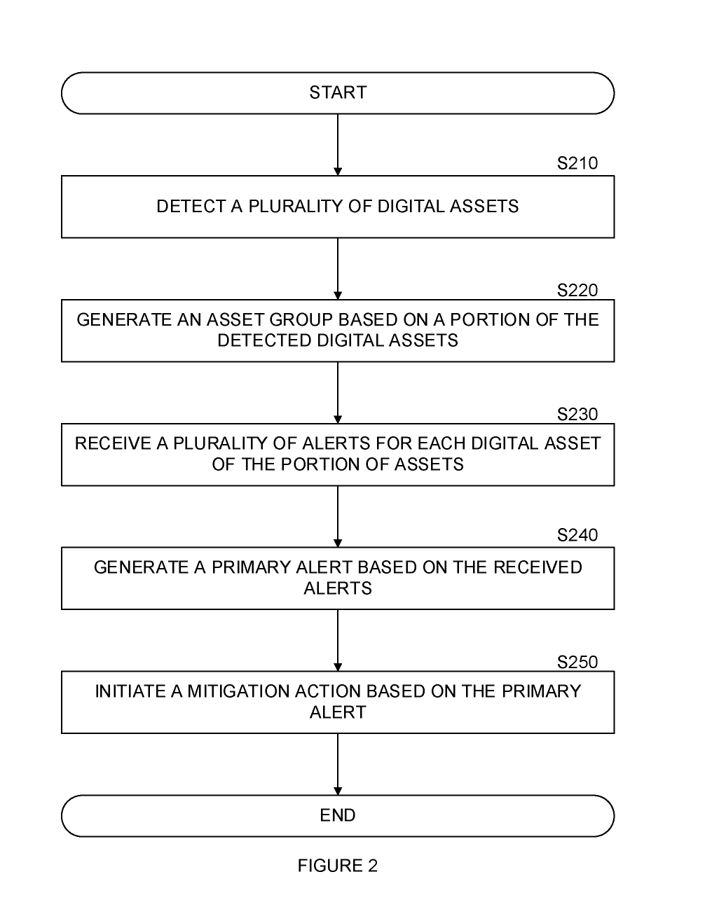

FIG. 2 is a flowchart of a method for detecting digital asset groups, implemented in accordance with an embodiment. In an embodiment, digital asset groups are detected to reduce a number of alerts generated by a system, to increase mitigation action effectiveness, etc.

At S210, a plurality of digital assets are detected. In an embodiment, at least a portion of the digital assets are detectable via a public network. A public network is, for example, the Internet. In an embodiment, a detector is configured to generate a representation of a digital asset.

In certain embodiments, the detector is configured to detect when digital asset information applies to an existing digital asset (e.g., a change of IP address), or when digital asset information applies to a new digital asset. In some embodiments the detector is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector is configured to detect, extract, and the like, a value from digital asset information, and store such an extracted value in the digital asset representation of the digital asset.

In an embodiment, digital asset information includes a network address, a network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In certain embodiments, digital assets are detected periodically. For example, in an embodiment, a computing environment is scanned periodically to detect new digital assets, changes in existing digital assets, a combination thereof, and the like.

At S220, an asset group is generated. In an embodiment, an asset group is generated which includes a plurality of digital assets which are related, associated, etc. In some embodiments, the asset group is a representation which is connected to a plurality of representations, each representation of the plurality of representations corresponding to a digital asset.

According to an embodiment, an asset group is generated based on a heuristic, a rule, a policy, and the like, which is applied at least on a representation of a digital asset. In some embodiments, the asset group is further generated based on a network hierarchy which is determined for connected components.

In some embodiments, an asset group is generated based on a shared domain, sub-domain, IP address, range of IP addresses, group of IP addresses, owner of a DNS record, a combination thereof, and the like.

In certain embodiments, a generative artificial intelligence (AI) model is provided with a prompt and a plurality of detected digital assets, wherein the prompt when processed by the generative AI model outputs a probability that two or more detected digital assets are related (and therefore should be grouped). In an embodiment, the prompt is generated based on a predefined template. In some embodiments, retrieval augmented generation is utilized by the generative AI, for example utilizing a representation of the computing environment, the digital assets thereof, and the like. In certain embodiments, the generative AI is a language model, such as a large language model (LLM), a small language model (SLM), a convolutional neural network (CNN), a deep neural network, a generative adversarial network, a combination thereof, and the like.

At S230, a plurality of alerts are received. In an embodiment, an alert is received from each digital asset of an asset group. In some embodiments, an alert includes an event record, including an identifier of the digital asset, an identifier of the issue for which the alert is generated, an attribute value of the digital asset, various combinations thereof, and the like.

In some embodiments, the alerts are received from a monitoring system, actively generated, and the like. For example, a monitoring system is Snyk®. In an embodiment, actively generating an alert includes generating an access instruction to access a digital asset, such as a PING instruction with an IP address of the digital asset.

At S240, a primary alert is generated. In an embodiment, the primary alert is generated based on a plurality of event records, notifications, alerts, and the like. In an embodiment, the primary alert is generated respective of an asset group. In the example of FIG. 1, where the asset group includes a load balancer and 3 web servers, rather than generate an alert for each digital asset (e.g., each component of the asset group), a single alert is generated which indicates an issue with the asset group.

In an embodiment, only primary alerts are generated. For example, in an embodiment, a ticket system, such as Jira®, is configured to receive only primary alerts, and assign such alerts for remediation.

In some embodiments, generating only primary alerts allows to decrease the number of alerts generated, and thus reduce alert fatigue. Furthermore, the alerts which are generated provide a business context for an entire asset group, which is not provided when only alerts of multiple components are generated.

At S250, a mitigation action is initiated. In an embodiment, the mitigation action is generated based on the asset group. In some embodiments, a plurality of mitigation actions are generated, each targeted at one or more components of the asset group.

In an embodiment, a mitigation action includes generating a notification, generating an alert, and the like.

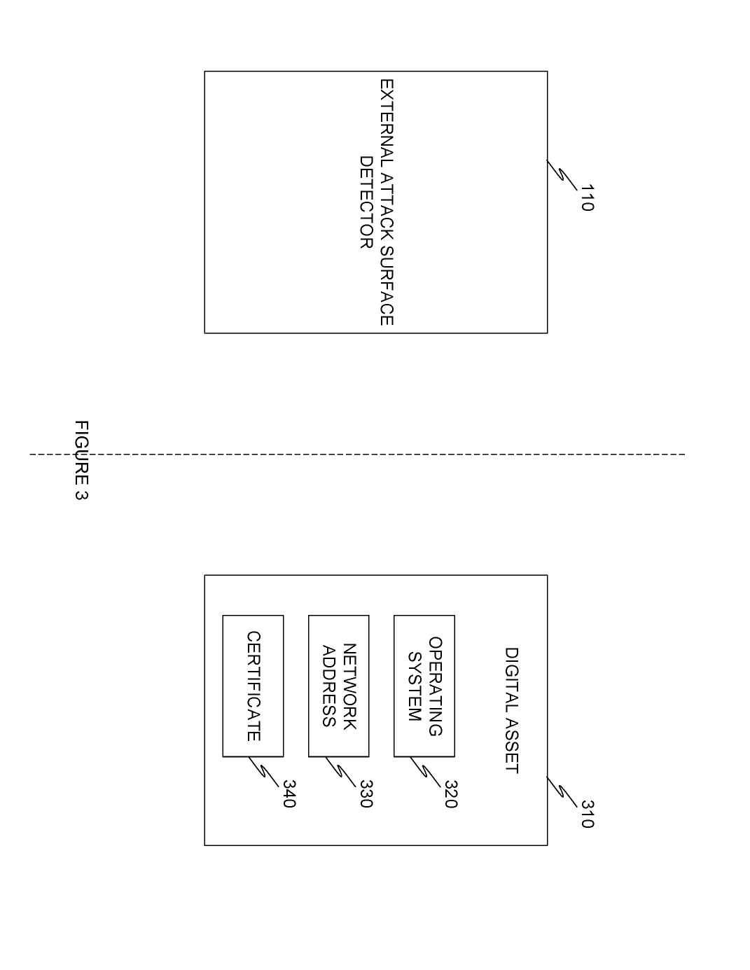

FIG. 3 is a diagram of an external attack surface detector and a digital asset, utilized to describe an embodiment.

An example of a detector 110 is described in more detail herein. In an embodiment, a detector 110 is implemented as a virtual machine, a software container, a serverless function, a combination thereof, and the like.

In an embodiment, an external attack surface detector 110 is configured to detect a digital asset 310. In an embodiment, the digital asset 310 is deployed in a networked computing environment. In some embodiments, a digital asset 310 consists of attributes, such as an operating system 320, a network address 330, a certificate 340, a combination thereof, and the like.

For example, a digital asset’s 310 operating system 320 can be Microsoft Windows, MacOS, a flavor of Linux, a UNIX based operating system, a proprietary OS, or the like.

For example, in an embodiment, a digital asset’s 310 network address 330, can refer to an external IP address, an internal IP address, a machine-specific address, a combination thereof, and the like.

In some embodiments, a digital asset’s 310 certificate 340, can refer to a PKI security certificate, or the like.

In certain embodiments, attributes of a digital asset 310 can change over time, thereby presenting a challenge. For example, in an embodiment, an operating system 320 is a first version (e.g., Windows® 10) at a first point in time, and a second version (e.g., Windows® 11) at a second point in time which is later than the first point. A detector 110 is configured to apply a rule, a policy, a condition, a heuristic, a combination thereof, and the like, to determine if a digital asset is a previously detected digital asset, or a new digital asset.

In some embodiments, the detector 110 is configured to generate a fingerprint for each digital asst. In certain embodiments, a fingerprint is a static collection of data pertaining to the digital asset (e.g., static values of attributes). In certain embodiments, the detector 110 is configured to determine if a digital asset is a previously detected digital asset or a new digital asset based on a fingerprint, or based on a portion of a fingerprint.

For example, in an embodiment, the detector 110 is configured to determine that a digital asset which has the same network address 330, same digital certificate 340, and a different operating system 320 is a previously detected digital asset, if the current operating system is of the same type (e.g., Windows, Linux, etc.) as the previously detected operating system.

As another example, in an embodiment, the detector 110 is configured to determine that a digital asset which has the same network address 330, the same digital certificate 340, and a different operating system 320 is a newly detected digital asset, where the current operating system (e.g., Windows) is of a different type as the previously detected operating system (e.g., Linux).

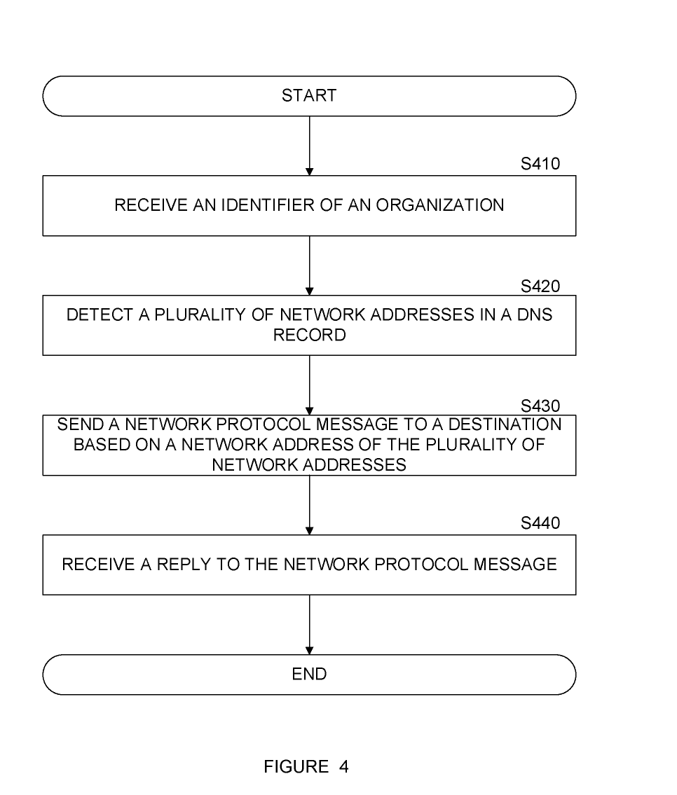

FIG. 4 is a flowchart of a method for detecting a digital asset in a networked computing environment, implemented in accordance with an embodiment.

At S410, an organization identifier is received. The organization identifier identifies the domain wherein scanning of digital assets should commence, according to an embodiment. An organization identifier is, for example, a legal entity name, a subsidiary name, a tax ID number, a company ID number, a combination thereof, and the like, in certain embodiments.

In an embodiment, the organization identifier is utilized in the configuration of an external attack surface detector. The external attack surface detector is configured to detect assets across a plurality of network addresses received in a DNS record, the record being the result of the DNS query for the domain identified by the organization identifier.

At S420, a plurality of network addresses is detected. In an embodiment, a network address corresponds to a DNS record located using the organization identifier. For example, in an embodiment, the DNS record is provided at S410.

In an embodiment, location of a domain associated with the DNS using the organization identifier can be achieved through Open-source Intelligence (OSINT) resources, publicly available lists of registered domains within popular domain registries (e.g., GoDaddy.com), utilizing a DNS lookup protocol (e.g., WHOIS) to query and retrieve information about a particular domain, a combination thereof, and the like.

In an embodiment, a DNS record is detected by querying a DNS server with the organization identifier. An organization identifier is, for example, a legal entity name, a subsidiary name, a tax ID number, a company ID number, a combination thereof, and the like.

In certain embodiments, a DNS query returns a response including a plurality of network addresses. For example, according to an embodiment, a DNS query response includes a static IP address, a dynamic IP address, a combination thereof, and the like.

At S430, a network protocol message is sent. In an embodiment, the network protocol message is sent to a destination, wherein the destination is based on a network address of the plurality of network addresses.

In an embodiment, a network protocol message is generated based on a network address detected in the DNS query response. For example, in an embodiment, a network protocol message includes generating a PING command to an IP address, a range of IP addresses, and the like, and receiving a response to the network protocol message.

In certain embodiments, the network protocol is TCP/IP, UDP, HTTP, SSH, a combination thereof, and the like. In some embodiments, the network protocol message is delivered over a unique port, a plurality of unique ports, and the like. For example, in an embodiment, an HTTP message is generated, and the same message is transmitted over port 80 and port 8080 to the same IP address.

In some embodiments, a message may be sent to a destination which yields no reply. The reasons for this can include: the destination refusing to accept messages at the sent location, the destination refusing to accept messages utilizing the selected communication protocol, the destination refusing to accept messages completely, the destination being a “dead” resource at the detected location, a combination thereof, and the like.

At S440, a reply is received. In an embodiment, the reply is received in response to a previously sent network protocol message. For example, in an embodiment, an HTTP response includes a code, such as 404, 503, etc. The protocol used to receive the reply must match the protocol used to send the message.

In certain embodiments, receiving a reply indicates that the asset is a component of the external attack surface. For example, if the asset provides a reply using a public communication protocol, such as HTTP, over a publicly accessible communication port, such as port 80, without requiring any authentication or authorization on behalf of the sender, the asset will be deemed to be part of the external attack surface.

In some embodiments, a reply is received using a protocol which expects some sort of credentials to be presented with the initial request. For example, according to an embodiment, a request may require that the requesting party provide authentication or security information (e.g.: a public key address, encrypted credentials, or the like). The asset may provide a reply which is not indicative of a security vulnerability, such as a HTTP code 401 indicating that the client sending the request is unknown to the asset. In these embodiments, the presence of a reply does not qualify the asset as being compromised, but can indicate that the asset is part of the external attack surface.

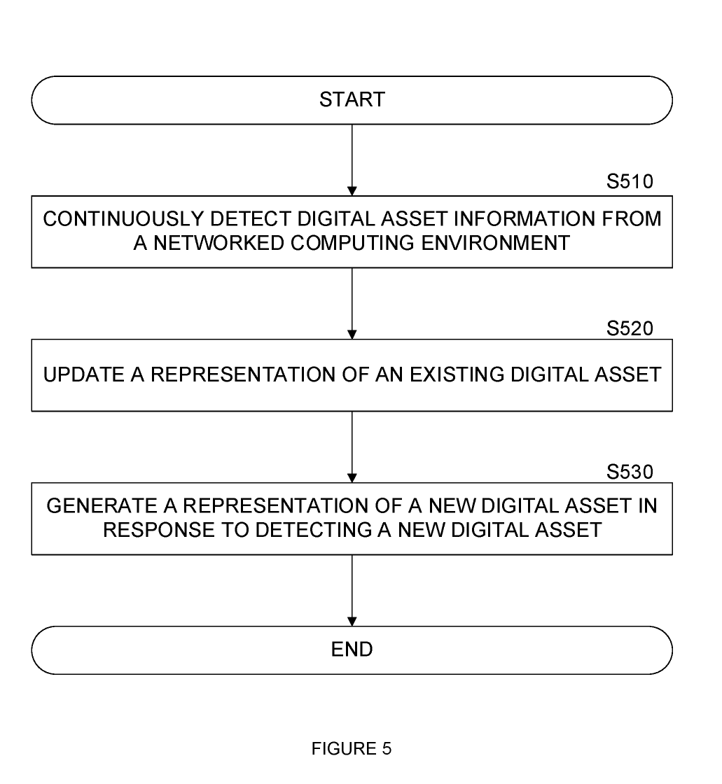

FIG. 5 is a flowchart of a method for detecting persistent digital assets in a networked computing environment, implemented according to an embodiment.

At S510, a persistent digital asset is detected. In an embodiment, a networked computing environment is continuously scanned for digital assets. In some embodiments, the network computing environment is scanned for digital assets at a predefined time, a predefined time interval, a combination thereof, and the like.

A network computing environment, according to an embodiment, includes virtual digital assets, physical digital assets, combinations thereof, and the like. In an embodiment, a virtual digital asset is a virtual machine, a software container, a serverless function, a virtual appliance, an application image, a web server, a load balancer, a database, a distributed storage service, a combination thereof, and the like.

In some embodiments, a physical digital asset is a bare metal machine, a server rack, a processor, a memory, a storage, combinations thereof, and the like.

In an embodiment, digital asset information includes a network address, a port, network address range, a domain identifier, a sub-domain name, a namespace identifier, a MAC address, an operating system identifier, an application version, an application identifier, a certificate, a hash of a certificate, a checksum result, a web application, an HTML code, a combination thereof, and the like.

In an embodiment, detecting digital assets in the networked computing environment is performed by an external attack surface detector, such as described in more detail herein.

In an embodiment, the detector (i.e., the external attack surface detector) is configured to extract a value from digital asset information, and store the extracted value in a representation of the digital asset, for example in a database.

Digital assets are often not static across time, which presents a challenge in identifying persistent digital assets. As a simple example, a digital asset has a first IP address at a first time, and a second IP address at a second time. This can occur, for example, due to a change in a static IP of a domain. In an embodiment, such a change is detected based on a DNS record.

In certain embodiments, the detector is configured to detect when digital asset information applies to an existing digital asset (e.g., a change of IP address), or when digital asset information applies to a new digital asset. In some embodiments the detector is configured to apply a policy, a rule, a conditional rule, a heuristic, a combination thereof, and the like, to determine if digital asset information is applied to a new digital asset or a previously detected digital asset.

In some embodiments, a digital asset representation includes a plurality of attributes, each attribute having a corresponding value. For example, in an embodiment, the detector is configured to detect, extract, and the like, a value from digital asset information, and store such an extracted value in the digital asset representation of the digital asset.

In some embodiments, the detector is configured to determine if a digital asset information applies to a new digital asset or a previously detected digital asset based on a threshold. For example, in an embodiment, an attribute includes a threshold, a change threshold, and the like. In certain embodiments, where an attribute value changes at a frequency which exceeds the threshold, the digital asset information is determined to be of a new digital asset.

In certain embodiments, a statistical distribution is determined for values of an attribute, a plurality of attributes, and the like. For example, according to an embodiment, a statistical distribution is determined for values of a communication port (e.g., 80, 20, 22, etc.). In an embodiment, port 5190 is determined to be an infrequent port, i.e., a communication port which is used infrequently, appears infrequently, and the like, for example based on a determined statistical distribution of port values.

In some embodiments, an infrequent value is an indicator of a persistent digital asset. For example, a first digital asset is detected with a first IP address, having an infrequent value for a communication port. At a second time, a second digital asset is detected with a second IP address, having the infrequent value for a communication port. In some embodiments, it is determined that the second digital asset is the first digital asset, due to a probability that the infrequent port value is below a threshold.

At S520, an existing digital asset representation of an existing digital asset is updated. In an embodiment, updating an existing digital asset representation is performed in response to an external attack surface detector determining that the digital asset information corresponds to a previously detected digital asset.

At S530, a new digital asset representation of a digital asset is generated. In an embodiment, the new digital asset representation is generated in response to an inspector determining that the digital asset information should apply to a new digital asset.

Generating a new digital asset includes, according to an embodiment: creating a new entry in a security database representative of the new digital asset. The representation of the new digital asset (as described, for example, in FIG. 3 310) includes information such as the detected asset’s operating system 320, the network address 330 of the asset, known and discoverable asset certificate information 340, any other asset identifier information known to, or discoverable by, the detector at the moment of entry creation, a combination thereof, and the like.

According to an embodiment, a new digital asset is one wherein previously known asset identifiers do not yield a suitable match, as determined by the inspector, following a query of the digital asset representation database.

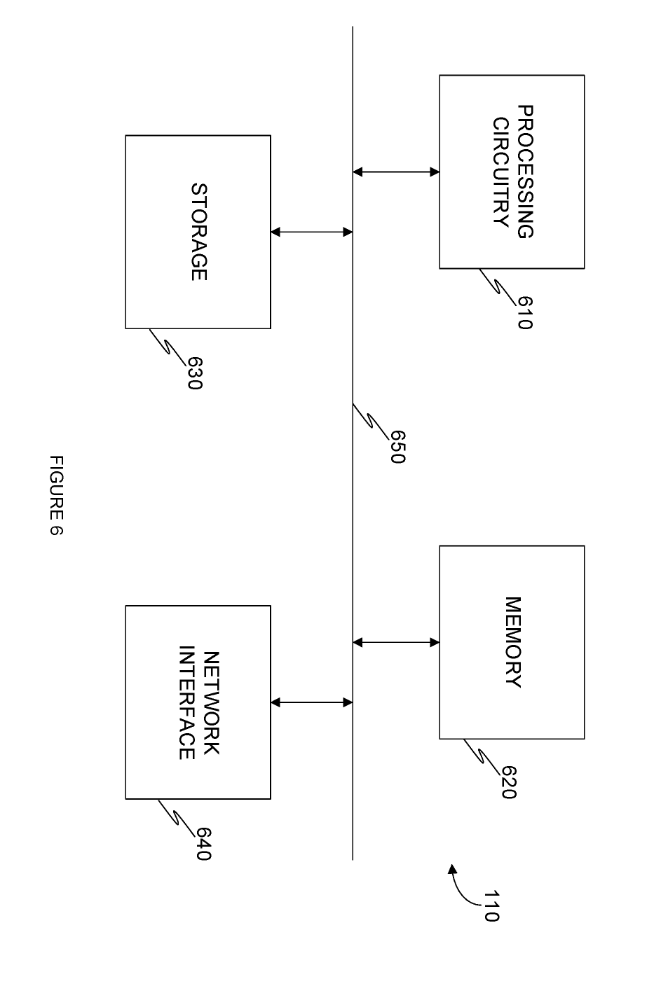

FIG. 6 is an example schematic diagram of a detector 110 according to an embodiment. The detector 110 includes, according to an embodiment, a processing circuitry 610 coupled to a memory 620, a storage 630, and a network interface 640. In an embodiment, the components of the detector 110 are communicatively connected via a bus 650.

In certain embodiments, the processing circuitry 610 is realized as one or more hardware logic components and circuits. For example, according to an embodiment, illustrative types of hardware logic components include field programmable gate arrays (FPGAs), application-specific integrated circuits (ASICs), Application-specific standard products (ASSPs), system-on-a-chip systems (SOCs), graphics processing units (GPUs), tensor processing units (TPUs), Artificial Intelligence (AI) accelerators, general-purpose microprocessors, microcontrollers, digital signal processors (DSPs), and the like, or any other hardware logic components that are configured to perform calculations or other manipulations of information.

In an embodiment, the memory 620 is a volatile memory (e.g., random access memory, etc.), a non-volatile memory (e.g., read only memory, flash memory, etc.), a combination thereof, and the like. In some embodiments, the memory 620 is an on-chip memory, an off-chip memory, a combination thereof, and the like. In certain embodiments, the memory 620 is a scratch-pad memory for the processing circuitry 610.

In one configuration, software for implementing one or more embodiments disclosed herein is stored in the storage 630, in the memory 620, in a combination thereof, and the like. Software shall be construed broadly to mean any type of instructions, whether referred to as software, firmware, middleware, microcode, hardware description language, or otherwise. Instructions include, according to an embodiment, code (e.g., in source code format, binary code format, executable code format, or any other suitable format of code). The instructions, when executed by the processing circuitry 610, cause the processing circuitry 610 to perform the various processes described herein, in accordance with an embodiment.

In some embodiments, the storage 630 is a magnetic storage, an optical storage, a solid-state storage, a combination thereof, and the like, and is realized, according to an embodiment, as a flash memory, as a hard-disk drive, another memory technology, various combinations thereof, or any other medium which can be used to store the desired information.

The network interface 640 is configured to provide the detector 110 with communication with, for example, the network 120, database 115, and the like, according to an embodiment.

It should be understood that the embodiments described herein are not limited to the specific architecture illustrated in FIG. 6, and other architectures may be equally used without departing from the scope of the disclosed embodiments.

Furthermore, in certain embodiments the database 115, detector 110, a combination thereof, and the like, may be implemented with the architecture illustrated in FIG. 6. In other embodiments, other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more processing units (“PUs”), a memory, and input/output interfaces. The computer platform may also include an operating system and microinstruction code. The various processes and functions described herein may be either part of the microinstruction code or part of the application program, or any combination thereof, which may be executed by a PU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for cybersecurity posture management including an external attack surface, comprising;
detecting a plurality of digital assets, wherein at least a portion of the plurality of digital assets are accessible through a public network;
generating an asset group based on a first digital asset and a second digital asset of the plurality of digital assets;
receiving alerts related to each of the first digital asset and the second digital asset;
generating a primary alert based on the received alerts; and
initiating a mitigation action based only on the primary alert.

2. The method of claim 1, further comprising:
assigning a priority to the mitigation action, wherein the mitigation action is a mitigation action of a plurality of mitigation actions.

3. The method of claim 2, further comprising:
initiating the mitigation action based on the assigned priority.

4. The method of claim 1, further comprising:
determining that the first digital asset is associated with the second digital asset; and
generating the asset group in response to determining the association.

5. The method of claim 1, further comprising:
determining that the first digital asset is associated with the second digital asset based on a domain name service (DNS) record.

6. The method of claim 1, further comprising:
generating a first fingerprint for the first digital asset;
generating a second fingerprint for the second digital asset;
determining that the first digital asset is associated with the second digital asset based on a match between the first fingerprint and the second fingerprint.

7. The method of claim 6, further comprising:
generating a third fingerprint for a third digital asset;
generating a second asset group in response to determining that the third fingerprint mismatches the first fingerprint; and
associating the third fingerprint with the second asset group.

8. The method of claim 1, further comprising:
initiating mitigation actions based only on primary alerts.

9. A non-transitory computer-readable medium storing a set of instructions for cybersecurity posture management including an external attack surface, the set of instructions comprising:
one or more instructions that, when executed by one or more processing circuitries of a device, cause the device to:
detect a plurality of digital assets, wherein at least a portion of the plurality of digital assets are accessible through a public network;
generate an asset group based on a first digital asset and a second digital asset of the plurality of digital assets;
receive alerts related to each of the first digital asset and the second digital asset;
generate a primary alert based on the received alerts; and
initiate a mitigation action based only on the primary alert.

10. A system for cybersecurity posture management including an external attack surface comprising:
one or more processing circuitries configured to:
detect a plurality of digital assets, wherein at least a portion of the plurality of digital assets are accessible through a public network;
generate an asset group based on a first digital asset and a second digital asset of the plurality of digital assets;
receive alerts related to each of the first digital asset and the second digital asset;
generate a primary alert based on the received alerts; and
initiate a mitigation action based only on the primary alert.

11. The system of claim 10, wherein the one or more processing circuitries are further configured to:
assign a priority to the mitigation action, wherein the mitigation action is a mitigation action of a plurality of mitigation actions.

12. The system of claim 11, wherein the one or more processing circuitries are further configured to:
initiate the mitigation action based on the assigned priority.

13. The system of claim 10, wherein the one or more processing circuitries are further configured to:
determine that the first digital asset is associated with the second digital asset based on a domain name service (DNS) record.

14. The system of claim 10, wherein the one or more processing circuitries are further configured to:
generate a first fingerprint for the first digital asset;
generate a second fingerprint for the second digital asset; and
determine that the first digital asset is associated with the second digital asset based on a match between the first fingerprint and the second fingerprint.

15. The system of claim 14, wherein the one or more processing circuitries are further configured to:
generate a third fingerprint for a third digital asset;
generate a second asset group in response to determining that the third fingerprint mismatches the first fingerprint; and
associate the third fingerprint with the second asset group.

16. The system of claim 10, wherein the one or more processing circuitries are further configured to:
determine that the first digital asset is associated with the second digital asset; and
generate the asset group in response to determining the association.

17. The system of claim 10, wherein the one or more processing circuitries are further configured to:
initiate mitigation actions based only on primary alerts.
